(19) United States
(12) Patent Application Publication
(10) Pub. No.: US 2019/0061539 A1
(43) Pub. Date: Feb. 28, 2019

(54) METHOD AND ADAPTER FOR COMMUNICATION WITH A CHARGING CABLE OF A BATTERY-POWERED ELECTRIC VEHICLE

(71) Applicant: HEIDELBERGER DRUCKMASCHINEN AG, HEIDELBERG (DE)

(72) Inventors: ROLF SPILGER, VIERNHEIM (DE); FRANK HEYNIG, LADENBURG (DE); JOCHEN BECHTLER, MALSCH (DE); TIMO BREUNINGER, MANNHEIM (DE)

(21) Appl. No.: 16/115,893

(22) Filed: Aug. 29, 2018

(30) Foreign Application Priority Data
Aug. 30, 2017 (DE) 10 2017 215 116.1

(51) Int. Cl. B60L 11/18; H01R 31/06

(52) U.S. Cl. CPC B60L 11/1818; H01R 31/065; B60L 2230/16; B60L 2230/12; B60L 2270/00

(57) ABSTRACT

A method for communication between an external computer and a charging cable with an in-cable control box for charging battery-powered electric vehicles includes providing the charging cable with a data line for communication with the vehicle. A hardware interface between control box and computer allows access to the data line through the computer. Data for the control box is sent from the computer to the hardware interface, modulated by the hardware interface to the signal of the data line, and transmitted to the control box. Data for the computer is sent from the control box through the signal of the data line, converted by the hardware interface, and sent to the computer. The data is sent from control box to computer by modification of the pulse width of the signal of the data line and sent to the hardware interface, which forwards the data to the computer.

### CROSS-REFERENCE TO RELATED APPLICATION

This application claims the priority, under 35 U.S.C. § 119, of German Patent Application DE 10 2017 215 116.1, filed Aug. 30, 2017; the prior application is herewith incorporated by reference in its entirety.

### BACKGROUND OF THE INVENTION

### Field of the Invention

The present invention relates to a method and an adapter for communication between a diagnostic PC and a charging cable for charging battery-powered electric vehicles having an in-cable control box.

The invention is in the technical field of a charging infrastructure for battery-powered electric vehicles.

A dedicated infrastructure is required for charging battery-powered electric vehicles. In addition to connection to the local power grids, that infrastructure chiefly includes various plug types and charging modes through the use of which the corresponding battery-powered electric vehicles may be charged. Under the international standard IEC 61851 for the conductive charging of battery-powered electric vehicles, a number of charging modes are specified, and various plug modes are referenced. There are four different charging modes, of which Mode 1 provides slow charging at household power outlets up to 16 A, and Mode 2 provides charging in single-phase or three-phase configurations up to 32 A. The other modes, Modes 3 and 4, include rapid charging at up to 250 amperes and direct current rapid charging at up to 400 amperes, respectively. Modes 1 and 2 allow the use of standard plug systems like Schuko, which makes it possible to connect to normal household power outlets. In Mode 2, the presence of an IC-CPD, short for “In Cable Control and Protective Device,” also known as an ICCB (“In Cable Control Box”) is required. That device takes over safety and communication functions for the process of charging through the power grid. With Modes 3 and 4 for rapid charging, such an IC-CPD is not required, because those functions are taken over by the rapid charging station.

The IC-CPD accordingly for example takes over communication with the vehicle electronics in such a way that the maximum possible charging current is communicated to the charging electronics in the vehicle. The IC-CPD also takes on other functions, such as monitoring the protective conductor, examining the electrical connections between PE conductor and metal body, the functionality of the residual current circuit breaker for avoiding electrical accidents, and monitoring or switching off the charging process in case of anomalous charging such as an exceedance of the maximum permissible charging current, or a plug temperature exceedance.

In order to perform those functions, the IC-CPD typically has an integrated circuit, in most cases a particular microcontroller with corresponding firmware. As with all embedded software products, a firmware update is also desirable for an IC-CPD. In addition, it is necessary to carry out fault diagnostics to read out a fault memory of the IC-CPD. For that purpose, a communication connection with the IC-CPD is necessary. However, because the charging cables, including the IC-CPD, must be well insulated for safe use and must have a high IP protection rating, such as IP64, it is extremely expensive to install additional hardware interfaces for a diagnostic plug in the housing of the charging cable or IC-CPD.

In principle it is possible to communicate with the IC-CPD through Powerline, but for that purpose the IC-CPD must be equipped with appropriate PLC hardware. Since that represents a considerable cost factor, implicating the cost-effectiveness of existing charging cables, an alternative possibility of communication with the IC-CPD of the charging cable is needed. Wireless communication interfaces such as WLAN or Bluetooth have the same problem as communication through PLC. In addition, additional hardware costs in the form of modems or modules would be necessary, with a corresponding impact on the cost-effectiveness of the charging cable.

### SUMMARY OF THE INVENTION

It is accordingly an object of the invention to provide a method and an adapter for communication with a charging cable of a battery-powered electric vehicle, which overcome the hereinafore-mentioned disadvantages of the heretofore-known methods and adapters of this general type and which permit communication between a diagnostic device, preferably a PC, and a charging cable having an in-cable control box, without needing additional communication modules in the in-cable control box and without affecting the IP protection class.

With the foregoing and other objects in view there is provided, in accordance with the invention, a method for communication between an external computer and a charging cable with an in-cable control box for charging battery-powered electric vehicles, wherein the charging cable has a data line for communication with the vehicle, and wherein a hardware interface between the in-cable control box of the charging cable and the computer allows access to the data line through the computer. According to the method, data for the in-cable control box of the charging cable is sent from the computer to the hardware interface, modulated by the hardware interface to the data-line signal, and thus transmitted to the in-cable control box of the charging cable, while data for the computer is sent from the in-cable control box of the charging cable through the data-line signal, is converted by the hardware interface, and is then sent to the computer. It is crucial for the method of the invention that the data line, through the use of which the IC-CPD or in-cable control box normally communicates with the charging circuit of the vehicle, is used to exchange data with the computer with which the in-cable control box is intended to communicate, i.e. the diagnostic PC. For this purpose, a hardware interface is used that is positioned between the in-cable control box of the charging cable and the computer. This hardware interface, which may be realized for example in the form of an adapter, is then directly connected to the computer, so that data that will be sent from the in-cable control box of the charging cable to the computer, is sent from the in-cable control box to the data line, so that the hardware interface, which has access to the data line, receives this data, and may convert the data and send it to the computer through a direct connection with the computer. Data that will be sent from the computer to the in-cable control box is first sent by the computer to the hardware interface through the direct connection and then modulated by the hardware interface to the data-line signal, and thus is sent to the in-cable control box of the charging cable. Through the use of the hardware interface, the internal communication channel of the in-cable control box, which is actually intended for communication with the battery-powered electric vehicle, is thus used to communicate directly with the computer, without an additional interface in the form of a diagnostic connector in the housing or any additional communication modules in the in-cable control box. In order to remain compatible with the relevant standards for charging a battery-powered electric vehicle through the charging cable with an in-cable control box conforming to IEC-61851 and IEC-62752, the communication between the adapter and the in-cable control box must comply with these standards. The use of such an adapter, which may be plugged in externally and only needs to be available to specialists in the workshop, is significantly less expensive than the standard installation of communication modules such as PLC, WLAN or Bluetooth inside the in-cable control box.

A preferred development of the method of the invention is that the data exchange between the hardware interface and the computer is realized by using a serial interface (e.g. USB, RS232, . . . ), and the data sent from the hardware interface is converted to a serial protocol.

Another preferred development of the method of the invention is that the data sent from the computer to the in-cable control box of the charging cable is modulated to the data-line signal by the hardware interface by modifying the voltage level, and in particular by amplitude shift keying (ASK). Communication from the computer to the in-cable control box of the charging cable is specified in greater detail under IEC 61851 Type 2. This standard specifies that communication to the in-cable control box is carried out by modifying the voltage level by amplitude shift keying. In the method of the invention, this is realized by the hardware interface in order to communicate with the in-cable control box by using standard-compliant levels.

A further preferred development of the method of the invention is that the data set from the in-cable control box of the charging cable is sent from the in-cable control box to the computer by modifying the pulse width of the data-line signal, and is then sent to the hardware interface, which forwards the data to the computer. The communication from the in-cable control box to the computer is also carried out in accordance with IEC 61851 Type 2, by using a pulse width modulation (PWM). In order to communicate with the computer through serial protocol, the pulse width modulated signals are correspondingly received on the signal line of the charging cable from the hardware interface, converted, and forwarded to the computer.

An added preferred development of the method of the invention is that the calculation for converting data sent from the in-cable control box of the charging cable to the computer by the hardware interface is performed by measuring the pulse width and time sequence of the data-line signal. The calculation of the data sent from the in-cable control box of the charging cable to the computer is performed by the hardware interface, which measures the pulse width of the signal and identifies the data transmitted based on the time sequence of the PWM signals. This data is then forwarded to the externally connected computer.

An additional preferred development of the method of the invention is that the data exchange is bidirectional and duplex-capable, as a result of simultaneously modulating the pulse width of the data-line signal and modifying the voltage level. The correspondingly bidirectional communication is fully duplex-capable. This means that data may be sent from the computer to the in-cable control box at the same time as data may be sent from the in-cable control box to the computer. This is because both directions of communication modulate different aspects or characteristics of the data signal. The in-cable control box modulates the data by manipulating the pulse width, while in the reverse direction, the hardware interface modifies the voltage level.

Another preferred development of the method of the invention is that a plurality of different pulse widths is used for modulating the pulse width of the data-line signal, and a plurality of different voltage levels is used for modifying the voltage level in order to increase the data transfer rate of the data exchange. Since ordinary communication by pulse width modulation and amplitude shift keying only allows a low data rate of not more than 111 byte/s, additional pulse widths and voltage levels may be used to encode correspondingly more bits, and thus a higher data transfer rate of up to 500 bytes/s may be achieved.

A further preferred development of the method of the invention is that for sending data from the computer to the in-cable control box of the charging cable, only the negative part of the voltage level is modified, in order to permit data exchange between the in-cable control box of the charging cable and the computer in parallel with the process of charging a battery-powered electric vehicle through the charging cable. Previous versions of the method of the invention used a hardware interface in the form of an adapter which was plugged into the socket of the in-cable control box, and then connected to the computer. The drawback of that procedure was that in that configuration, simultaneous charging of a battery-powered electric vehicle was not possible by using the charging cable with its in-cable control box. In order to enable that, an adapter with an additional plug is used, through the use of which, similar to a T-junction, the in-cable control box is connected to the battery-powered electric vehicle, while at the same time it is also connected to the computer. However, since the in-cable control box communicates with the charging circuit of the battery-powered electric vehicle through standard-compliant pulse width modulation and amplitude shift keying of the positive signal level, communication between the in-cable control box and the computer must be adjusted. Since the in-cable control box cannot communicate simultaneously with the battery-powered electric vehicle and the computer or hardware interface that converts the data from the in-cable control box for the computer, a third communication channel must be created. The negative level of the data signal is used for that purpose. For the foregoing communication to the in-cable control box, only the positive level is used by amplitude shift keying. Consequently, an additional communication channel is available by modifying the negative level. According to this variant of the method, thus, the data signal is modified three times over: first, through pulse width modulation for communication of in-cable control box with the battery-powered electric vehicle; second, by amplitude shift keying of the positive signal level for communication of the battery-powered electric vehicle with the in-cable control box; and third, by amplitude shift keying of the negative signal level for communication between in-cable control box and hardware interface or connected computer. In this method, however, communication between the in-cable control box and hardware interface is only possible in half-duplex. This means that sending or receiving may occur in the communication channel between the hardware interface or computer and the in-cable control box. Consequently, communication with the hardware interface is performed according to the master-slave principle. In other words, the computer sends a request to the in-cable control box through the hardware interface, and the in-cable control box then responds accordingly to this request.

An added preferred development of the method of the invention is that the modification of the negative voltage level is time-delayed, in such a way that the modified voltage levels fit into the low phase of a PWM signal, thereby increasing the data transfer rate of the data exchange. Since modifications of the negative voltage level again only enable correspondingly low data transfer rates of 111 byte/s, a further development of the method is that the modified negative voltage levels are adapted within the low range of a PWM signal. This makes it possible to increase the data transfer rate to up to 1,000 bytes/s.

An additional preferred development of the method of the invention is that the data sent from the in-cable control box of the charging cable to the computer include data for fault diagnosis and operating statistics. The data sent from the in-cable control box to the computer is mainly fault diagnosis data. Ordinarily, the fault memory of the in-cable control box is read out and the contents thereof are then sent to the computer. However, the data may also generally include information about operational statistics useful for evaluating the use of the in-cable control box or for calculating the costs of the charging process.

Another preferred development of the method of the invention is that the data sent from the computer to the in-cable control box of the charging cable includes software updates for the in-cable control box of the charging cable. However, other types of data such as configuration files or the like are also possible.

With the objects of the invention in view, there is also provided an adapter that realizes a hardware interface for carrying out the method of the invention, in which the adapter has a vehicle connector that plugs into the vehicle coupling of the in-cable control box, and a USB connector that connects the adapter to the computer, while a microcontroller located in the adapter is set up so as to effect a data exchange between the computer and the in-cable control box of the charging cable through a serial interface. In order to realize the corresponding method of this invention, a hardware interface is necessary, which is realized in the form of an adapter. This adapter is plugged into the vehicle coupling of the in-cable control box, which is normally connected to the battery-powered electric vehicle. The vehicle connectors and vehicle couplings that are used are specified in the IEC 62196 standard. The adapter has a corresponding vehicle connector, which is connected to the vehicle coupling of the in-cable control box, and an additional plug, for example in the form of a USB connector, which is then connected to the computer. The adapter further has a microcontroller with an integrated serial interface, through the use of which data exchange is carried out between the adapter and the computer. The vehicle couplings, or vehicle connectors, have the usual three phases L1 to L3, a neutral conductor, a protective conductor and the data signal line (CP signal). This makes it possible to contact the internal data line by which the in-cable control box normally communicates with the battery-powered electric vehicle, and to use it for communication with the computer.

A further preferred development of the adapter according to the invention is that the adapter also has a vehicle coupling, in addition to the vehicle connector, and this coupling is connected to a battery-powered electric vehicle, making it possible to simultaneously charge the battery-powered electric vehicle and exchange data with the computer through a serial interface. In this additional variant, the adapter has an additional vehicle coupling, so that it has a vehicle connector, a vehicle coupling and a USB connector. In this way, the in-cable control box may connect simultaneously to the battery-powered electric vehicle and the external computer, similar to a T-junction. In this way, the battery-powered electric vehicle may be charged at the same time that communication occurs between the computer and in-cable control box.

A concomitant preferred development of the adapter according to the invention is that the adapter is set up in such a way as to use negative and positive voltage levels having amplitude values that cannot be generated by the battery-powered electric vehicle on the data line in order to make contact with the in-cable control box. The level having an amplitude value of −12 V was chosen because an electric vehicle (EV) cannot produce this. Thus, it may be safely distinguished from the electric vehicle. If the IC-CPD is in fault state F (CP signal −12 V), the adapter will change this level to +12 V. The electric vehicle also cannot generate this level in this state.

Other features which are considered as characteristic for the invention are set forth in the appended claims.

Although the invention is illustrated and described herein as embodied in a method and an adapter for communication with a charging cable of a battery-powered electric vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram illustrating a charging process of a battery-powered electric vehicle;

FIG. 2 is a block diagram illustrating communication according to the invention by using a charging cable;

FIG. 3 is a diagram illustrating a functional structure of an adapter, with a pin assignment;

FIG. 4 is a block diagram illustrating simultaneous implementation according to the invention, of communication with the charging cable and charging of the battery-powered electric vehicle;

FIG. 5 is a diagrammatic, perspective view of a structural organization of the adapter with a housing;

FIG. 6 is a circuit diagram of a system according to the invention, in a first embodiment;

FIG. 7 is a diagram illustrating modulation of the data on a signal line according to the invention, in a first embodiment;

FIG. 8 is a circuit diagram of the system according to the invention, in a second embodiment;

FIG. 9 is a circuit diagram of the system according to the invention, in a third embodiment;

FIG. 10 is a diagram illustrating modulation of the data on the signal line according to the invention, in a third embodiment; and

FIG. 11 is a diagram illustrating modulation of the data on the signal line according to the invention, in a fourth embodiment.

### DETAILED DESCRIPTION OF THE INVENTION

Communication between a charging cable or IC-CPD 3 and a battery-powered electric vehicle 6 is regulated according to the IEC-61851 and IEC-62752 standards. This provides, among other things, that the charging cable, i.e. the IC-CPD 3, has a PWM generator with 1 kOhm internal resistance, the fundamental frequency of the pulse width modulated signal 13 (PWM signal) is 1 kHz, information sent from the charging cable (IC-CPD 3) to the battery-powered electric vehicle 6 is transmitted by changing the pulse width, and information sent from the battery-powered electric vehicle 6 to the charging cable (IC-CPD 3) is transmitted by changing the positive signal level.

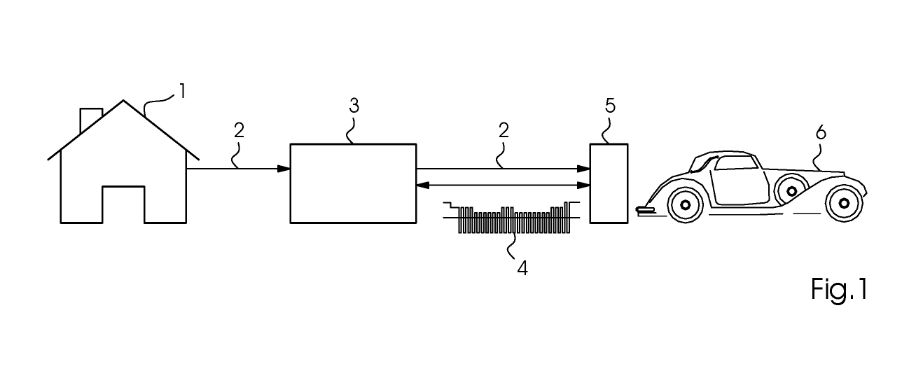

Referring now to the figures of the drawings in detail and first, particularly, to FIG. 1 thereof, there is seen an example of a structural organization of the battery-powered electric vehicle 6, a charging cable, and a power grid 1 that provides a charging current 2. A standard charging cable has no additional interfaces for fault diagnostics or software updates. Additional wireless interfaces that would be possible include Bluetooth, WLAN, and Zigbee©. Possible wired interfaces include USB 9, RS232 or Ethernet (TCP/IP). All these interfaces share the drawback that additional manufacturing costs for the (externally accessible) interface are incurred and the product becomes accordingly more expensive. In addition, a wired interface must be sealed.

The present invention avoids these drawbacks. Communication for fault diagnosis, information exchange and software update may take place without additional hardware in the charging cable.

Based on the requirements of IEC-61851 and IEC-62752, several methods have been developed for communication with the charging cable.

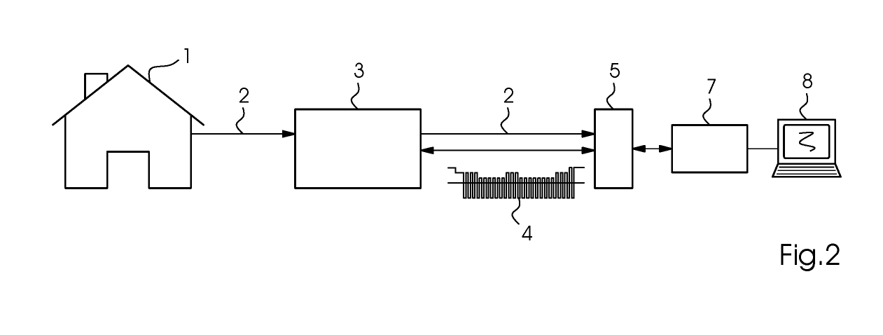

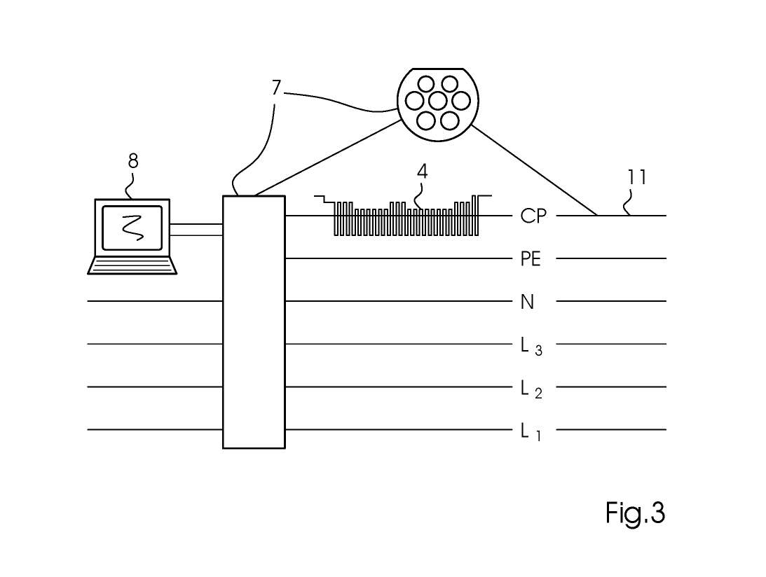

In order to implement these methods, a special communication adapter 7 is connected between the charging cable 2 and a computer in the form of a diagnostic PC 8. FIG. 2 shows the necessary structural organization between the charging cable and the diagnostic PC 8, through the use of which data 4 for fault diagnosis and/or firmware updates of the IC-CPD 3 may be replaced. FIG. 3 schematically shows the organization for this purpose. The drawing shows how the CP signal 4 is detected and evaluated by using the adapter 7. Also shown are pins of a corresponding vehicle connector 10 for Mode 2, which are used by the adapter 7.

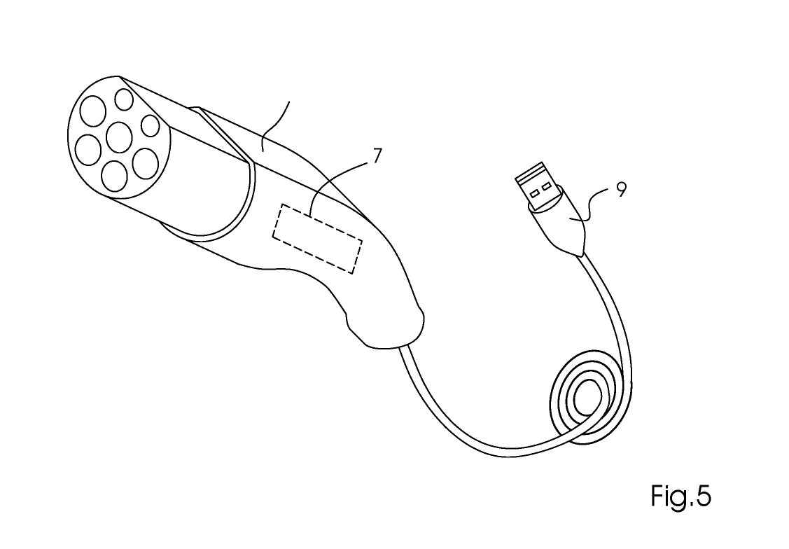

In addition, FIG. 5 shows the structural organization of an adapter 7 integrated into a vehicle connector 10 according to IEC 62196 Type 2, for connecting to a vehicle coupling 5 of the IC-CPD 3, as well as the structural organization of a type A USB connector 9 for connecting to the diagnostic computer 8, together with the housing thereof.

The adapter 7 has a microcontroller that controls the data transfer between the IC-CPD 3 and the diagnostic PC 8. This adapter fundamentally measures the pulse width of the PWM signal 13 on a CP signal line 11. The adapter calculates the byte sent by the charging cable from the time sequence of the measured pulse widths, and sends it on to the diagnostic PC 8 through a standard interface (UART). Furthermore, the communication adapter 7 receives information from the diagnostic PC 8 at the UART interface and forwards it to the charging cable by modifying the voltage levels of the data signal 4.

In order to establish a communication connection to the charging cable, the communication adapter brings the CP signal 4 to −12 V for 50 ms. Then it is checked whether or not the charging cable is in the communication mode (i.e. whether the PWM signal 13 is on). If not, the process is repeated with +12 V. If no communication with the charging cable is established after 1 second, the process is aborted.

The −12 V level was chosen because an electric vehicle (EV) cannot produce it. Thus, it may safely be distinguished from the electric vehicle. If the IC-CPD is in a fault state F (CP signal −12 V), the communication adapter changes this level to +12 V. The electric vehicle also cannot produce this level.

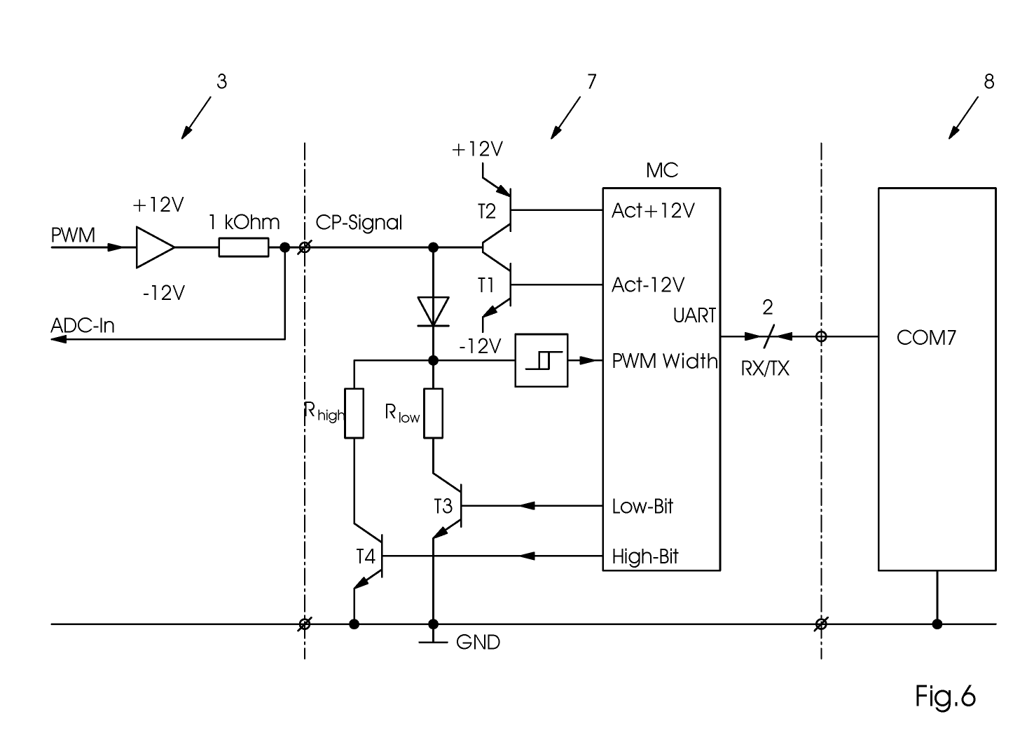

The schematic structure of the overall system, with the relevant components of the adapter 7, the diagnostic PC 8 and the IC-CPD 3, is disclosed in the form of a circuit diagram in FIG. 6. FIG. 6 shows a first preferred embodiment in which the diagnostic PC 8 is connected directly to the vehicle coupling 5 of the IC-CPD 3 through the adapter 7. In this case, during communication, the charging cable cannot be used simultaneously for charging the battery-powered electric vehicle 6, because the output of the IC-CPD 5 is occupied by the plug 10 of the adapter 7.

During the connection setup, the IC-CPD 5 applies +12 V (state A) to the CP signal 4. As soon as the communication adapter 7 has received the command to establish communication from the diagnostic PC 8, it switches the CP signal 4 to −12 V for 50 ms with the signal Act-12 V and t1. When the IC-CPD 3 detects this, the PWM signal 13 is enabled. The low bit and high bit are each assigned a voltage level for data exchange from the communication adapter 7 to the IC-CPD 3. The low bit and high bit each have a pulse width assigned to the CP signal 4 for data exchange from the IC-CPD 3 to the communication adapter 7. Since the PWM frequency is set to 1 kHz in the IEC-61851 standard and only one bit is transmitted per PWM pulse, the achieved transmission rate is only 111 bytes/sec (8N1).

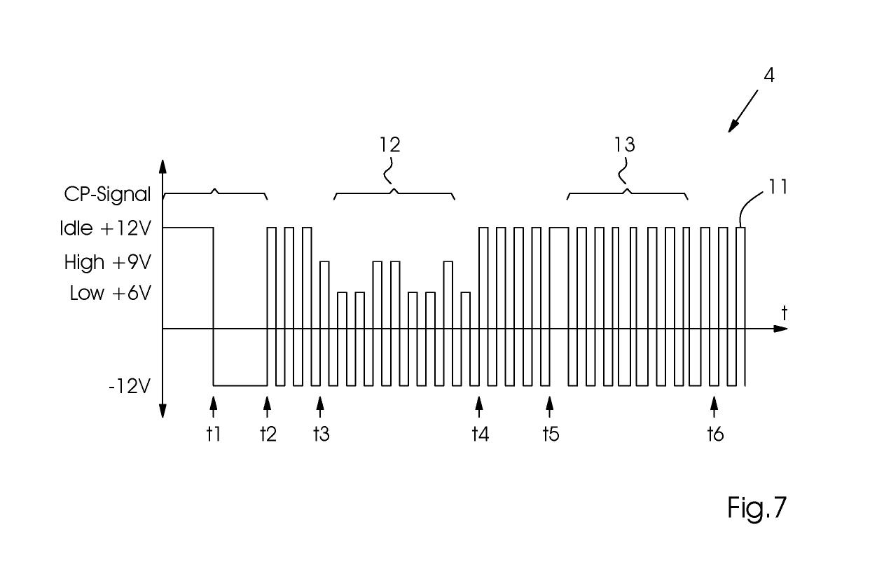

FIG. 7 shows the CP signal during connection setup and communication. At the time t1, the communication adapter 7 sets the CP signal 4 to −12 V and instructs the IC-CPD 3 to establish the communication connection. At a time t2, the communication adapter 7 switches the −12 V off again. Thus, the PWM signal 13 (pulse width idle), which the IC-CPD 3 has now switched on, may take precedence. At a time t3, the communication adapter 7 begins sending a byte to the IC-CPD 3 by using amplitude shift keying 12. First, a start bit (level high) is transmitted, followed by 8 data bits (MSB-first 00110010t−>0×32). At a time t4, the transmission is completed. At a time t5, the IC-CPD 3 begins sending a byte to the communication adapter 7. First a start bit (300 μs wide) is sent, followed by 8 data bits MSB-first 11001101t−>0×cd.

Since sending and receiving refer to different aspects of the CP signal 4, the transmission is fully duplex-capable. Since communication from the IC-CPD 3 to the diagnostic PC 8 is done by PWM, while communication in the reverse direction is done by amplitude shift keying 12, both are possible at the same time. In other words, sending and receiving may take place independently of one another.

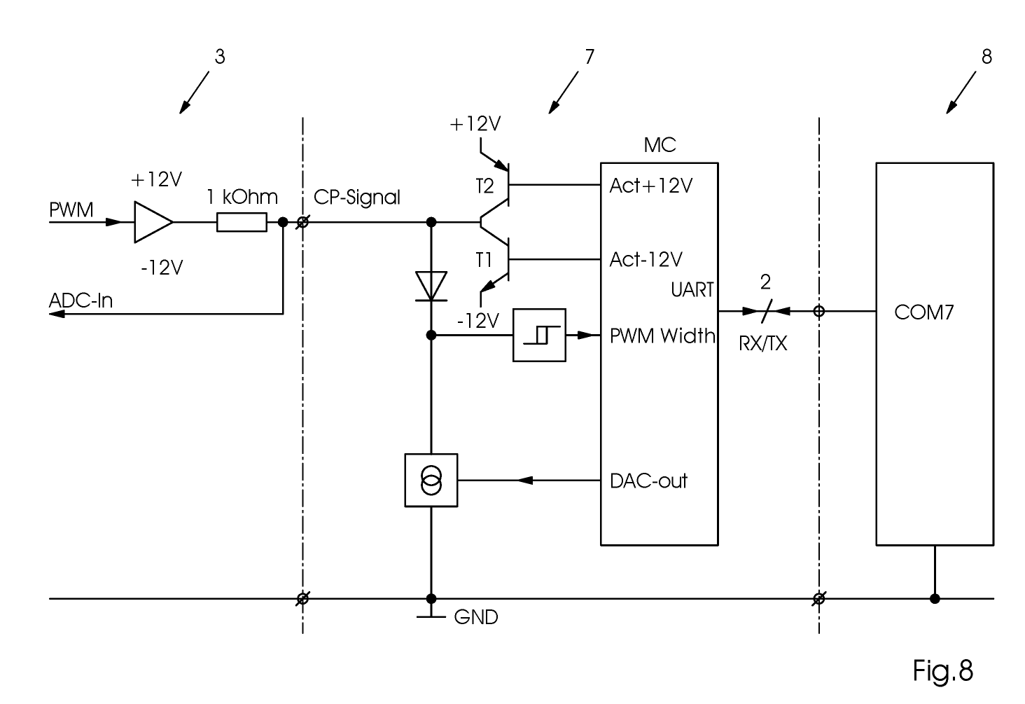

A second preferred embodiment of the method is proposed in order to increase the transmission rate or data transfer rate. The correspondingly necessary hardware configuration is shown in FIG. 8. In this variant, a plurality of voltage levels, preferably 16, are used to encode the information sent from the communication adapter 7 to the IC-CPD 3. Likewise, a plurality of different pulse widths, preferably 16, are used on the CP signal 4 to encode the information sent from the communication adapter 7 to the IC-CPD 3. For this purpose, T3, T4, R_{low}, and R_{high} are replaced by a controllable power source. This allows a plurality of bits to be transmitted per PWM pulse. Since one byte may thus be transmitted with two PWM pulses, the transmission rate increases to 500 bytes/sec. (16 levels at 8N0). Theoretically, this quantization may be increased even further. However, this also increases the requirement for data acquisition in the IC-CPD 3, which in turn leads to additional costs.

The following table shows an example of a 16-bit quantization:

| Level [V] | Current [mA] | Pulse width [μs] | Coding |
|---|---|---|---|
| 9.000 | 3.000 | 950 | 1111t -> 0xf -> 15 |
| 8.625 | 3.375 | 900 | 1110t -> 0xe -> 14 |
| 8.250 | 3.750 | 850 | 1101t -> 0xd -> 13 |
| 7.875 | 4.125 | 800 | 1100t -> 0xc-> 12 |
| 7.500 | 4.500 | 750 | 1011t -> 0xb -> 11 |
| 7.125 | 4.875 | 700 | 1010t -> 0xa -> 10 |
| 6.750 | 5.250 | 650 | 1001t -> 0x9 -> 9 |
| 6.275 | 5.625 | 500 | 1000t -> 0x8 -> 8 |
| 6.000 | 6.000 | 450 | 0111t -> 0x7 -> 7 |
| 5.625 | 6.375 | 400 | 0110t -> 0x6 -> 6 |
| 5.250 | 6.750 | 350 | 0101t -> 0x5 -> 5 |
| 4.875 | 7.125 | 300 | 0100t -> 0x4 -> 4 |
| 4.500 | 7.500 | 250 | 0011t -> 0x3 -> 3 |
| 4.125 | 7.875 | 200 | 0010t -> 0x2 -> 2 |
| 3.750 | 8.250 | 150 | 0001t -> 0x1 -> 1 |
| 3.375 | 8.625 | 100 | 0000t -> 0x0 -> 0 |

The previously disclosed preferred embodiments 1 and 2 communicate in the positive level of the CP signal 4. The pulse width is also used for communication. This means that the diagnostic PC 8 takes the place of the battery-powered electric vehicle 6 and thus it is not possible to communicate simultaneously with charging of the vehicle battery.

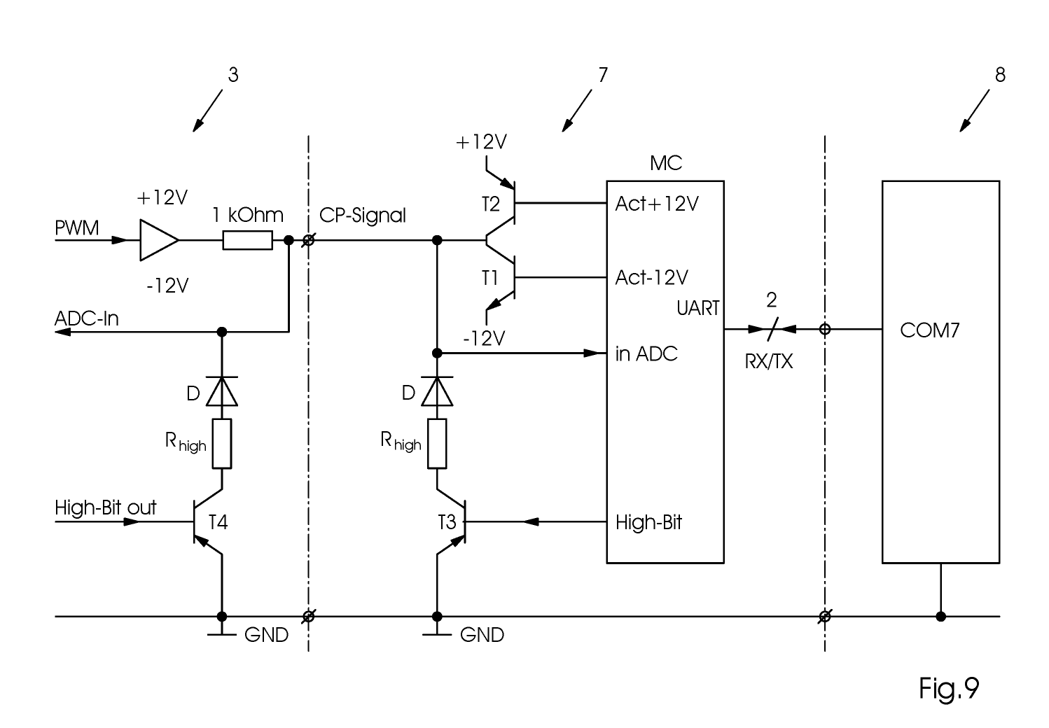

In order to enable this, a third preferred embodiment is disclosed that eliminates this limitation. In Variant 3, only the negative level of the CP signal 4 is used for communication with the diagnostic PC 8. However, since both directions of communication between the diagnostic PC 8 and the IC-CPD 3 use the negative level, only a half-duplex operation is possible. In other words, the IC-CPD 3 responds only to a request from the diagnostic PC 8 and the IC-CPD 3 is not permitted to transmit independently (master-slave operation). For transmission, the low and high logic states are each assigned a voltage level: for example, low −12 V and high −11.5 V. The high level is determined by the selection of components T3/4 R_{low}, and D (see FIG. 9). The levels in this example were chosen to be within the tolerance range of the IEC-61851 standard (−12 V +/−1 V). The above-described connection setup procedure is used only when the communication adapter 7 determines that the IC-CPD 3 is in the A state. If the IC-CPD 3 is already in charging mode (state C) or state D, a connection is not necessary.

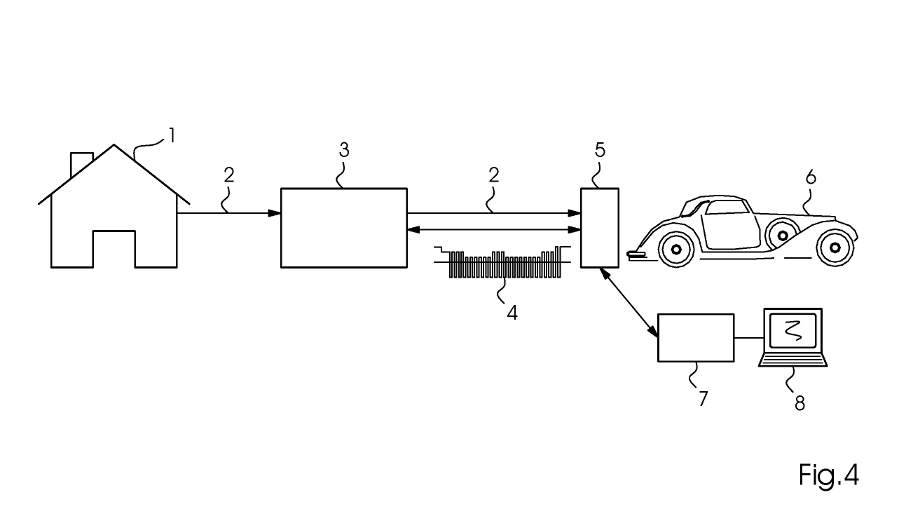

A corresponding change of the hardware of the adapter 7 is necessary for the third preferred embodiment. This is shown in the circuit diagram of FIG. 9. The schematic relationship for the overall system for simultaneous charging and communication with the IC-CPD 3 through the adapter 7, however, may be seen in FIG. 4.

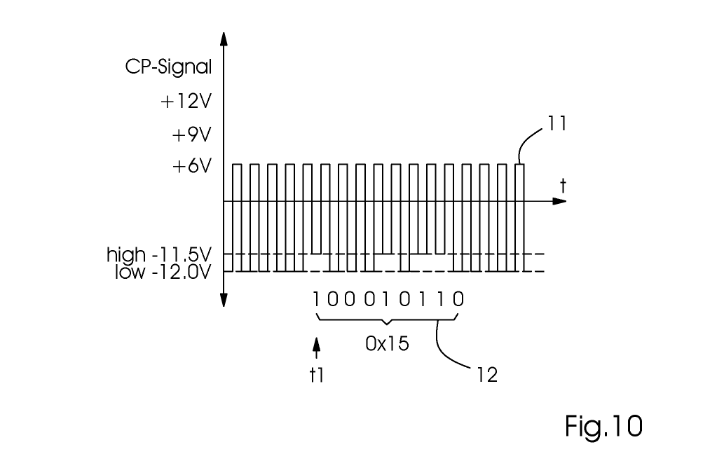

FIG. 10 shows, by way of example, the signal curve during charging for the communication according to the invention. At the time t1, a start bit (−11.5V) is transmitted, followed by 8 data bits (0010110t−>0×15). The transmission does not use a stop bit or parity bit. The achieved transmission rate is 111 byte/sec.

Since the transmission rate in the third preferred embodiment is very low, a fourth preferred embodiment is presented. Variant 4 differs from Variant 3 only in that the transmission of a byte is compressed in time in such a way that it fits into the low phase of a PWM signal 13. The hardware used remains unchanged. Only the firmware in the microcontroller of the adapter 7 and in the IC-CPD 3 for evaluating the CP signal 4 is adjusted.

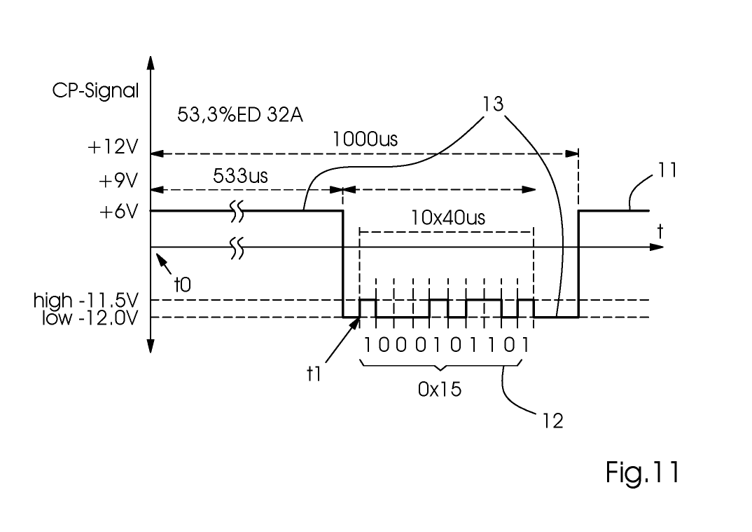

FIG. 11 shows the method of the invention for the fourth preferred embodiment. The position of the start bit (t1) is always synchronous with the positive edge of the PWM signal 13 at t0+560 μs. Thus, it may be ensured that charging may still take place at 32 A (53% ED) and that transmission does not take place in the positive part of the PWM signal 13. FIG. 11 shows how a start bit, 8 data bits (MSB-first) and a parity bit are transmitted. A transmission error may be detected by using a parity bit. The transmission rate achieved is thus 1000 bytes/sec, which is significantly higher than in the third preferred embodiment.

The following is a summary list of reference numerals and the corresponding structure used in the above description of the invention:

1 Power grid

2 Charging current/energy

3 IC-CPD

4 CP data signal

5 Vehicle coupling

6 Battery-powered electric vehicle

7 Communication adapter

8 Diagnostic PC

9 USB connection

10 Vehicle connector

11 CP data line

12 Amplitude-modulated signal

13 Pulse width-modulated signal

1. A method for communication between an external computer and a charging cable having an in-cable control box for charging battery-powered electric vehicles, the method comprising the following steps:
providing the charging cable with a data line for communicating with the vehicle;
using a hardware interface between the in-cable control box of the charging cable and the computer to allow access to the data line through the computer;
sending data for the in-cable control box of the charging cable from the computer to the hardware interface, modulated to a signal of the data line by the hardware interface and transmitting the data to the in-cable control box of the charging cable, while sending data for the computer from the in-cable control box of the charging cable through the signal of the data line being converted by the hardware interface and sent to the computer; and
sending the data from the in-cable control box of the charging cable from the in-cable control box of the charging cable to the computer, modulated by modifying a pulse width of the signal of the data line and sent to the hardware interface which forwards the data to the computer.

2. The method according to claim 1, which further comprises exchanging data between the hardware interface and the computer by using a serial interface, and converting the data sent from the hardware interface to a serial protocol.

3. The method according to claim 1, which further comprises using the hardware interface to modulate the data sent from the computer to the in-cable control box of the charging cable by modifying a voltage level of the signal of the data line.

4. The method according to claim 3, which further comprises modifying the voltage level by amplitude shift keying.

5. The method according to claim 1, which further comprises performing a calculation for converting data sent from the in-cable control box of the charging cable to the computer by the hardware interface by measuring the pulse width and time sequence of the signal of the data line.

6. The method according to claim 3, which further comprises simultaneously modulating the pulse width of the signal of the data line and modifying the voltage level to make the data exchange bidirectional and duplex-capable.

7. The method according to claim 3, which further comprises using a plurality of different pulse widths for modulating the pulse width of the signal of the data line, and using a plurality of different voltage levels for modifying the voltage level in order to increase a data transfer rate of the data exchange.

8. The method according to claim 3, which further comprises modifying only a negative part of the voltage level for sending data from the computer to the in-cable control box of the charging cable, in order to allow a data exchange between the in-cable control box of the charging cable and the computer in parallel with a process of charging the battery-powered electric vehicle through the charging cable.

9. The method according to claim 8, which further comprises time-delaying the modification of the negative voltage level to permit the modified voltage levels to fit into a low phase of a PWM signal, thereby increasing a data transfer rate of the data exchange.

10. The method according to claim 1, which further comprises including data for fault diagnosis and operating statistics in the data sent from the in-cable control box of the charging cable to the computer.

11. The method according to claim 1, which further comprises including software updates for the in-cable control box of the charging cable in the data sent from the computer to the in-cable control box of the charging cable.

12. An adapter implementing a hardware interface for communication between an external computer and a charging cable having an in-cable control box for charging battery-powered electric vehicles according to claim 1, the adapter comprising:
a vehicle connector according to IEC 62196-2 being plugged into a vehicle coupling of the in-cable control box according to IEC 62196-2;
a USB connector connecting the adapter to the computer; and
a microcontroller configured to carry out a data exchange between the computer and the in-cable control box of the charging cable through a serial interface.

13. The adapter according to claim 12, wherein said serial interface is a USB interface.

14. The adapter according to claim 12, which further comprises a further vehicle coupling connected to the battery-powered electric vehicle for charging the battery-powered electric vehicle simultaneously with data exchange with the computer through the interface.

15. The adapter according to claim 12, wherein the adapter is configured to use negative and positive voltage levels with amplitude values that cannot be generated on the data line by the battery-powered electric vehicle, in order to make contact with the in-cable control box.
